(19) United States
(12) Patent Application Publication
(10) Pub. No.: US 2003/0139966 A1
(43) Pub. Date: Jul. 24, 2003

(54) Advertisement delivery for streaming program

(76) Inventors: Peter L. Sirota, Seattle, WA (US); Donald E. Johnson, Seattle, WA (US); Sudheer Tumuluru, Seattle, WA (US); Paul S. Vandergrift, Seattle, WA (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/056,262

(22) Filed: Jan. 23, 2002

(51) Int. Cl. G06F 17/60

(52) U.S. Cl. 705/14; 725/42

(57) ABSTRACT

Advertisements of various time lengths, preferably consumer tailored, are pre-cached on consumer client systems of a streaming program. Selected ones of advertisements are synchronously rendered at advertisement time slots of the streaming program, effectively substituting or replacing advertisements, if any, included with the streaming program for the advertisement time slots. In various embodiments, the advertisements are downloaded to the client systems in an adaptive manner, such that the downloads are substantially non-interfering to the receipt and rendering of the streaming program.

### BACKGROUND OF THE INVENTION

1. Field of the Invention

The present invention relates to the field of data processing. More specifically, the present invention relates to the rendering of advertisements for streaming programs.

2. Background Information

With advances in integrated circuit and microprocessor, processor based computing devices are increasingly more powerful in terms of their processing capabilities. Processing power that was once available only in the most expensive mainframe systems are now available in even many entry level hand held consumer devcies. As a result, increasinly, processing intensive rich multi-media contents are being made available and consumed on even the most basic ones of these processor based computing devices.

Concurrently, advances in networking and communication technologies have resulted in increasing number of these processor based computing devices being networked together. Such devices are often first coupled with a local area network, such as an Ethernet-based office/home network. In turn, the local area networks are interconnected together through wide area networks. Of particular importance is the global inter-network, the Internet. As a result of this trend of increased connectivity, an increasing amount of these rich multi-media contents are made available, distributed, or broadcast online.

Online broadcasting invloves the continuous streaming of programmed content from broadcasting servers to networked client systems for consumption. Streamed programming, as its brethren of the earlier generation, i.e. broadcast programming over air waves or cable network, typically contains advertisements at periodic advertisement time slots. In fact, for many content broadcasters, such as radio or television programming, for efficiency reasons, the streamed programming is the exact mirror image of the programming broadcast over the air waves or cable network, thus containing the same advertisements at the corresponding advertisement time slots.

Accordingly, a number of problems or undesirable characteristics arise. First, by operation of law, or contractual obligations, it is at times inappropriate for the broadcasters to repeat rendering of the same advertisements in the streamed programming. However, re-processing or regeneration of the programming without or with different advertisemens for streaming is a costly solution. Further, even if it is not inappropriate to re-broadcast the same advertisements in streamed programs, a number of these advertisements are not the most suitable advertisements, given the different delivery medium, as well as different consuming audience. Moreover, replacing the on-air advertisements with other advertisements targeted for the streaming medium presents the broadcasters with opportunities to collect additional revenues for the same advertisement time slots.

Thus, an advertisement delivery approach that can overcome, at least partially, these problems/undesirable characteristics, and/or being able to exploit the capabilities of the new delivery medium is desired.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates an overview of the present invention, in accordance with one embodiment;

FIG. 2 illustrates the method of the present invention, in accordance with one embodiment;

FIG. 3 illustrates the operations associated with pre-caching advertisements in further detail, in accordance with one embodiment; and

FIG. 4 illustrates an internal component view of a digital system suitable for use to practice the present invention, in accordance with one embodiment.

### DETAILED DESCRIPTION OF THE INVENTION

The present invention includes a novel advertisement delivery scheme for streaming programs. The scheme advantageously enables a content broadcaster to efficiently replace advertisements, if any, included in a streaming program, thereby enabling the broadcasters to be able to efficiently reuse the same programming designed for broadcast in the traditional medium, i.e. air waves or cable network. Moreover, the present invention, as will be readily apparent from the description to follow, advantageously enables the advertisements to be more tailored for the consumers of the streamed programming, as well as the advertisers to be able to more closely monitor the rendering and consumption of their advertisements, and in turn, to be more effective in gauging the effectiveness of advertisement campaigns.

In the description to follow, various aspects of the present invention will be described, and specific configurations will be set forth. However, the present invention may be practiced with only some or all aspects, and/or without some of these specific details. In other instances, well-known features are omitted or simplified in order not to obscure the present invention.

The description will be presented in terms of operations performed by a processor based device, using terms such as multi-media contents, requesting, downloading, rendering, and the like, consistent with the manner commonly employed by those skilled in the art to convey the substance of their work to others skilled in the art. As well understood by those skilled in the art, the quantities take the form of electrical, magnetic, or optical signals capable of being stored, transferred, combined, and otherwise manipulated through mechanical, electrical and/or optical components of the processor based device.

Moreover, the term “processor” includes microprocessors, micro-controllers, digital signal processors, and the like, that are standalone, adjunct or embedded. Further, the term “processor based computing devices” (hereinafter, simply computing device) includes but is not limited to wireless mobile phones, palm sized personal digital assistants, notebook computers, desktop computers, set-top boxes, game consoles, servers, and so forth. The term “advertisement” includes commerical, public interest and filler messages of all form and all media types, and the term “advertisement time slots” includes programming breaks or interruptions of all time durations for the purpose of rendering “advertisements”. The term “caching” refers to the act of storing data coupled with a pre-determined and/or configurable policy for displacing prior stored contents to make room for new contents, in the event the allocated storage for storing such contents have become fully utilized. The term “rendering” refers to the process of physically manifesting content for the consumption and/or enjoyment by a user, including but not necessarily limited to visual and/or audible manifestation.

Various operations will be described as multiple discrete steps in turn, in a manner that is most helpful in understanding the present invention, however, the order of description should not be construed as to imply that these operations are necessarily order dependent. In particular, these operations need not be performed in the order of presentation.

The description repeatedly uses the phrase “in one embodiment”, which ordinarily does not refer to the same embodiment, although it may. The terms “comprising”, “including”, “having”, and the like, as used in the present application, are synonymous.

Overview

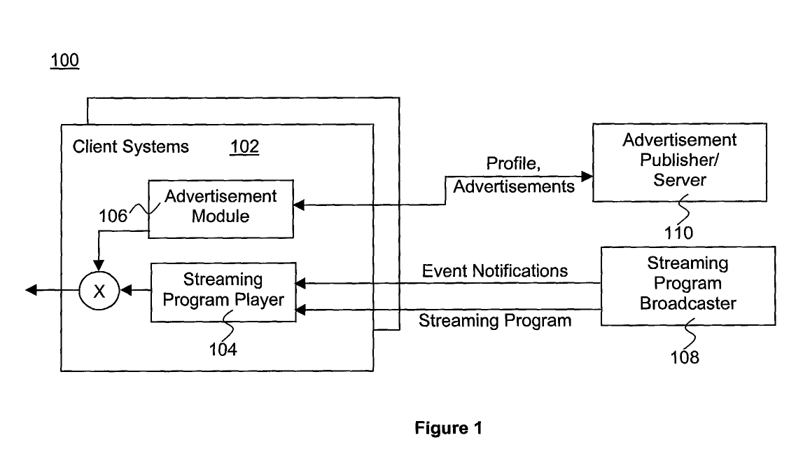

Referring now to FIG. 1, wherein a block diagram illustrating an overview of the present invention, in accordance with one embodiment, is shown. As illustrated, for the embodiment, consumer client systems 102 of streaming content or programming, in addition to conventional streaming program player 104 are individually provided with advertisement module 106 incorporated with the teachings of the present invention. Further, client systems 102 are communicatively coupled with streaming program broadcaster 108 and advertisement publisher/server 110.

Streaming program player 104 performs its conventional function of receiving and rendering streaming content or programs from streaming program broadcaster 108. For the embodiment, it is assumed that in conjunction with the streaming content or program, broadcaster 108 also provides a companion stream of event notifications. Included among the event notifications, of particular interest, are event notifications associated with the occurrences of advertisement time slots, including the time length or duration of each of these advertisement time slots.

As will be described in more detail below, advertisement module 106 incorporated with the teachings of the present invention, advantageously renders an appropriate amount of pre-cached advertisements in each of these advertisement time slots, enabling any advertisements included with the streaming content or program to be replaced. Moreover, by tailoring the type of advertisements pre-cached from advertisement publisher/server 110, the replacement advertisements may also be advantageously more targeted for the individual consumers of the various client systems 102.

Further, as will be also described in more detail below, in one embodiment, pre-caching of the advertisements from advertisement publisher/server 110 are adaptively performed, even while the receipt of the streaming content or program are in progress, to maintain availability of the substitute or replacement advertisements. The adaptive manner of downloading the advertisements substantially ensures that interference to the delivery of the streaming content or program is insignificant or inconsequential. As a result, a compelling advertisement replacement mechanism may nevertheless be effectuated even under a very limited or small bandwidth network connection.

Streaming content or a streaming program may be any such single or multi-media content or program known in the art or developed in the future, including but are not limited to streaming radio and/or television programming over the internet, an intranet, cable, radio waves or any telephony system. An example of streaming program player 104 is the Real One Player, available from Real Networks, Inc., of Seattle, Wash.

Client system 102 represents a broad range of digital systems known in the art, including but are not limited to devices such as wireless mobile phones, palm sized personal digital assistants, notebook computers, desktop computers, set-top boxes, and game consoles.

Streaming program broadcaster may be any one of a number of public and/or private streaming program broadcasters known in the art. An example of a public streaming program broadcaster is Real Networks, Inc. Another example of a program broadcaster is a radio station like WSTRFM of Atlanta, Ga. An example of a private streaming program broadcaster is a large enterprise streaming private contents or programs to a number of its geographically dispersed private audience.

Advertisement publisher/server 110 may be any one or more of these entities known in the art. An example of an advertisement publisher is DoubleClick of New York, N.Y.

In a preferred embodiment, client systems 102, streaming program broadcaster 108 and advertisement publisher/server 110 are coupled with each other over a public inter-network, specifically the Internet. Client systems 102, streaming program broadcaster 108 and advertisement publisher/server 110 communicate with each in accordance with standard based messaging and communication protocols, such as the Hypertext Transfer Protocol (HTTP) conducted in accordance with the Transmission Control Protocol/Internet Protocol (TCP/IP). In alternate embodiments, the present invention may be practiced with part or all of the various participants being communicatively coupled with others using other equivalent communication connections and protocols.

Advertisement Method of the Present Invention

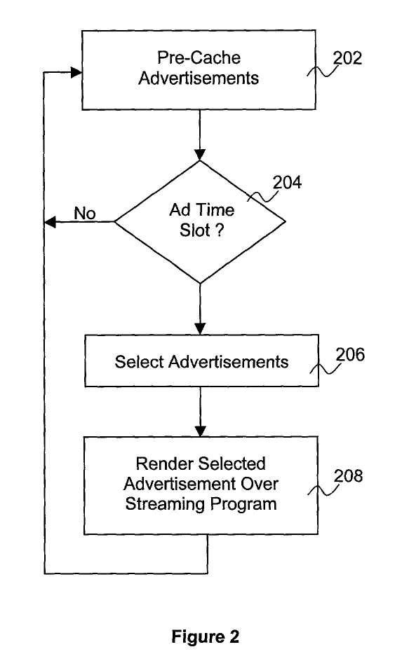

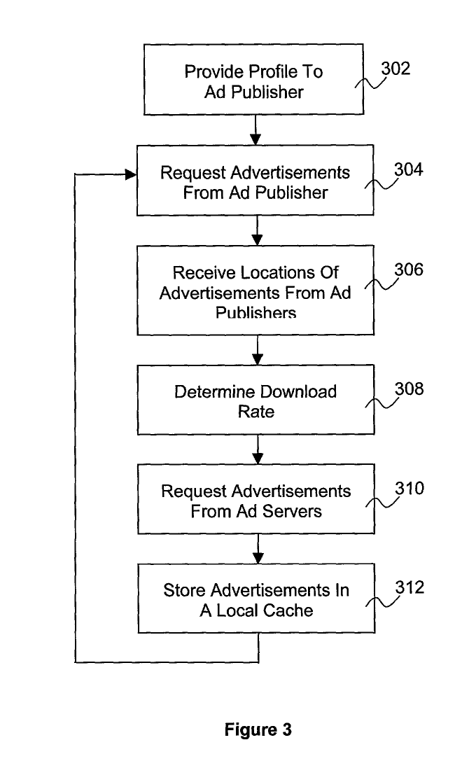

FIG. 2 illustrates an overview of the advertisement method of the present invention, in accordance with one embodiment. As illustrated, advertisement module 104 first pre-schedules a number of substitute/replacement advertisements for playing, block 202. The nature of the advertisements pre-scheduled, and the manner in which the advertisements are downloaded and scheduled, under presently preferred embodiments will be described more fully below, with references to FIG. 3. In various embodiments, to facilitate ease of retrieval for real time responsive rendering, upon being notified of an advertisement time slot or play window, the downloaded advertisements are stored in play queues on a play or time length basis. More specifically, in one embodiment, two play length based queues are employed, a 30 second advertisement queue and a 60 second advertisement queue. That is, for the embodiment, the downloaded advertisements are of either 30 seconds or 60 seconds in play length, and upon downloaded, they are queued for playing in the respective play queues.

The play queues may be implemented using any one of a number of data structures known in the art, in particular, those that are conveniently supported by the underlying operating system services of client systems 102.

Thereafter, i.e. upon pre-queuing n numbers of advertisements in the respective play queues, advertisement module 106 begins to listen for notifications of upcoming advertisement time slots in the streaming content or program being received and rendered on client system 102. While waiting, advertisement module 106 continues its process of building up or replenishing its advertisement play queues until they are filled.

However, upon being notified of an upcoming advertisement time slot, including its time length, advertisement module 106 selects a combination of cached advertisements having a total playtime at least equal to the time length of the upcoming advertisement time slot, block 206.

For the earlier described two queues embodiment, advertisement module 106 simply selects the queued advertisements primarily by their play lengths. For example, if the slot time length is 0 to 30 seconds, a 30 second advertisement is selected; if the slot time length is 31 to 60 seconds, a 60 second advertisement is selected. If the slot time length is greater than 60 seconds, a 60 second advertisement is selected, and the process is repeated for the residual playing time.

A number of fail-safe techniques may be employed to ensure that adequate advertisements would be available. In one embodiment, while an advertisement is discarded from the play queues, they are nevertheless kept in the advertisement caches (until they are evicted by additional incoming advertisements while the cache is full). In another embodiment, advertisement module 106 maintains certain default advertisements, e.g. its own advertisements, and play them in default, in the event the advertisement cache or queues become empty (except for the special “fall back” advertisements).

Continuing to refer to FIG. 2, upon selecting the appropriate combination of advertisements, advertisement module 106 causes the advertisements to be rendered. In one embodiment, advertisement module 106 also causes the output of streaming program player 104 to be muted or blocked, thereby effectuating the desired substitution or replacement, block 208. In one embodiment, if the total play length of the selected advertisement is longer than the advertisement time slot's play length, advertisement module 106 simply terminates the advertisement rendering at the end of the advertisement time slot, thereby refrains from intruding into the streaming content or program.

As alluded to earlier, upon rendering the selected advertisements, for the embodiment, the advertisements (except for the default or fail-safe protection ones) are discarded from the play queues. In other words, for the embodiment, the responsibility for the “scheduling” and “frequency of play” of the advertisements is substantially that of the advertisement publisher/server 110, by virtue of the advertisements it provides to client system 102. However, in alternate embodiments, the present invention may be extended to have at least part of the “scheduling” and “frequency of play” responsibility being distributed to and placed on client systems 102.

From block 208, the process returns to block 202, and continues from there as earlier described. The process continues cyclically until execution of advertisement module 106 is terminated, which may be caused for any reason, and in any one of a number of program termination techniques.

Pre-Caching Advertisements

FIG. 3 illustrates the process of pre-caching advertisements in further details, in accordance with one embodiment. As illustrated, for the embodiment, to facilitate the tailoring of the delivered advertisements to the consumers of client system 102, advertisement module 103 generates and provides a profile of the user to advertisement publisher/server 110, block 302, allowing advertisement publisher/server 110 to provide the advertisements based at least in part on the information provided in the profile.

In one embodiment, the profile includes demographic as well as interest information about the user or consumer. Examples of demographic information are age, sex, education and so forth, whereas examples of interest information are rock and roll music, sky diving, sailing and so forth. In one embodiment, the profile also includes geographic information such as zip code.

In one embodiment, to the extent that any of these profile information are available from player 104, advertisement module 106 obtains the information from player 104. For the rest of the profile information, at an appropriate time, e.g. installation of advertisement module 106, or thereafter periodically, until the user provides the information or instructs advertisement module 106 not to seek such information again, advertisement module 103 prompts the content/program consumer user of a client system 106 for the earlier mentioned demographic and interest information about the consumer. In one embodiment, the prompt also seeks the consent of the user in providing the information to advertisement publisher/server 110.

In alternate embodiments, advertisement module 106 may also be equipped to include with the profile interest or other information automatically collected by advertisement module 106 itself. Such information may include e.g. the streaming content or program consumed on client system 102 over a period. In fact, advertisement module 106 may be equipped to construct the profile strictly based on these automatically collected information, and skipping the earlier described operation of collecting inputs from the user.

Upon having gathered the profile information, advertisement module 106 generates a consumer profile based on the information provided/collected, and forwards the consumer profile to advertisement publisher/server 110.

Continuing to refer to FIG. 3, upon furnishing advertisement publisher 110 with the user profile, for the embodiment, advertisement module 106 requests advertisements from advertisement publisher 110, block 304. For the embodiment, it is assumed that advertisement publisher 110 instead of returning the selected advertisements directly, would advantageously return a list of locations from which the selected advertisements may be retrieved instead, thereby allowing advertisement module 106 to be able to advantageously control the download to ensure non-consequential impact on the streaming program being received and rendered by player 104 of the client system 102. As alluded to earlier, the present invention allows advertisement publisher 110 to provide the advertisements based at least in part on the provided profile of the consumer. Such selection may be effectuated in any one of a number of weighted or un-weighted techniques known in the art. Therefore, upon selection, as alluded to earlier, the locations from which the advertisements may be retrieved are returned, and received by the requesting client system 102, more specifically, advertisement module 106 of the client system 102.

Then, as alluded to earlier, advertisement module 106 determines an appropriate download rate for downloading the advertisements, such that downloading of the advertisements will not consequentially interfere, or at least not in a discernable manner, with the quality of the streaming program, block 308.

In one embodiment, to further reduce the amount of download, advertisement module 106 maintains a cache of the downloaded advertisements. In the event advertisement module 106 is instructed to download and play an advertisement that is still being cached, advertisement module 106 retrieves the advertisement from its local cache instead.

In one embodiment, the download rate is determined based on the estimated available bandwidth of client system 106. In one embodiment, the available bandwidth is operationally estimated by incrementally increasing the download rate (starting with an arbitrarily small download rate), and for each download rate, monitors the impact of the download on the streaming program.

In one embodiment, the impact is gauged using indicators such as the late arrival rate, loss and resend rate of the packets associated with the streaming content or program.

For the purpose of this application, late arrival rate means the rate the packets of the streaming content or programs arrive at the client system 102 out of order. For example, if packet 5 of the streaming program arrives before packet 4 of the streaming program, packet 4 of the streaming program is considered a late packet. If this occurs once out of every 10 packets, the late arrival rate is 10%.

Note that late arrival in and of itself does not necessarily has a manifested degradation in quality to the user, as packets generally arrive sufficiently in advance of the time they are needed. Nevertheless, late arrival could be a leading indicator to such observable degradation in quality of the streaming program.

Once determined, advertisement module 106 periodically requests advertisement server or servers 110 for the identified advertisements, block 310. Upon receipt, advertisement module 106 caches the received advertisements, block 312. In one embodiment, advertisement module 106 also queues the advertisements by their play lengths as earlier described.

As the bandwidth consumption of any streaming program is non-monotonic, and fluctuates over time, thus in the presently preferred embodiment, advertisement module 106 continues to monitor the impact of the advertisement download, and adjust the download rate as appropriate to continually ensure the impact of the advertisement download on the streaming program will be non-consequential.

In one embodiment, the bandwidth consumption is regulated employing a pair of operational parameters (bit rate, pulse rate). The two parameters represent a single packet payload, hence an estimate of the bit-pipe usage at a given instant. For example, a 30-second file sampled at 8 kbps is approximately 245,760 bits (or 30,720 bytes) long. To serve this file at 3 kbps, the server would take 80 (245,760/3,072) seconds. At this rate, to serve payloads of 96 bytes each, the server would have to have a pulse rate of 4. (30,720/(80×96)). Thus, by controlling the ‘bit-rate’ and the ‘pulse-rate’, it is possible to control the fraction of the bit-pipe to be used.

Therefore, consumption of the bit-pipe may be reduced or “down shifted” by employing lower bit rate and pulse rate, or higher pulse rate at the same bit rate; and increased or “up shifted” by employing higher bit rate and pulse rate.

Thus, in one embodiment, the consumption of bit-pipe is controlled as follows:

1. Choose the initial download rate depending on what stream the user has chosen to play (high vs. low) and based on the user bandwidth setting in the player.

2. Downshift when either the advertisement is not successfully downloaded within the expected time or an error is received while buffering the ad. (The assumption is that the bit-pipe is too congested to allow this content to be downloaded at the current rate within the specified time).

3. Downshift when a certain number of audio-feed packets are lost (A conservative assumption is that the ad-buffering process occupies too much of the bandwidth leading to this packet loss).

4. Downshift when a certain number of audio-feed packets arrive later than expected (latency is higher than certain threshold usually about ˜5%).

5. Downshift when a certain number of audio-feed packets were requested to resend by the player. If the player does not receive expected packet in time, it may request a packet resent from the server. The advertisement module monitors this activity and the downshift is performed when a certain threshold is reached (usually ˜2%).

6. Up-shift when an advertisement is successfully cached within the expected time and with no audio-feed problems.

7. Up-shift if a pre-determined number of advertisement are successfully cached following a previous downshift.

For the embodiment, while a single reference number 110 is employed to refer to advertisement publisher and server, in practice, advertisement publisher and server may be the same or different entities. Typically, they are different entities; in fact, typically, multiple servers are employed.

Advertisement Play Tracking

Referring back to FIG. 2, in one embodiment, advertisement module 106 is also equipped to facilitate advertisement publisher 110 in tracking the playing of the provided advertisements, thereby allowing more accurate accounting for the playing and possibly better assessment on the effectiveness of advertisement campaigns, as well as better compensation arrangement between the advertisement publisher and the advertisers. In one embodiment, at block 208, upon commencement of the playing of an advertisement, advertisement module 106 sends a commencement message notifying advertisement publisher 110 of the commencement of play. In like manner, upon completion of the playing of the advertisement, advertisement module 106 sends an end-of-play message notifying advertisement publisher 110 play of the advertisement has ended, thereby allowing advertisement publisher 110 to more accurately track the total play time of each provided advertisement, on each consumer client system 102.

The above referenced “commencement” and “end-of-play” messages may be implemented using any number of predetermined message formats, which are well within the ability of those skilled in the art to define, accordingly will not be further described. As alluded to earlier, in one embodiment, these messages are HTTP messages transmitted in accordance with the TCP/IP protocol.

Example Computer System

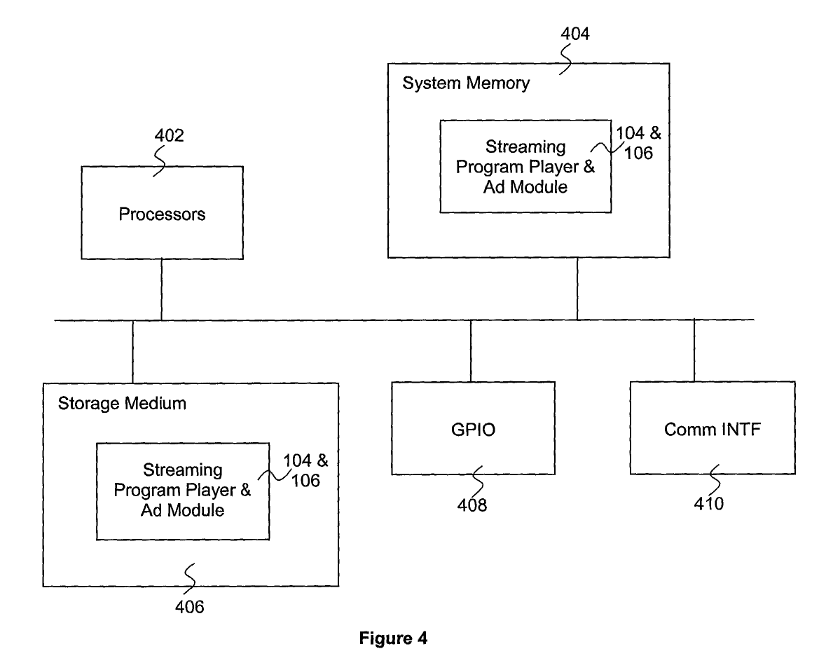

FIG. 4 illustrates an example computer system suitable for use to practice the present invention in accordance with one embodiment. As shown, computer system 400 includes one or more processors 402 and system memory 404. Additionally, computer system 400 includes mass storage devices 406 (such as diskette, hard drive, CDROM, RAM, DVD and so forth), general purpose input/output interface 408 (for interfacing input/output devices such as keyboard, cursor control and so forth) and communication interfaces 410 (such as network interface cards, modems and so forth). In accordance with the claimed invention, a storage medium may include a mass storage device, system memory or any device where information may be stored in electrical, optical and/or other encoded form. The elements 402-410 are coupled with each other via system bus 412, which represents one or more buses. In the case of multiple buses, they are bridged by one or more bus bridges (not shown).

Each of these elements 402-410 performs its conventional functions known in the art. In particular, communication interface 410 includes associated device drivers to facilitate communications in accordance with the communication protocol relied by streaming program player 104 and advertisement module 106. Further, system memory 404 and mass storage 406 are employed to store a working copy and a permanent copy of the programming instructions implementing the earlier described digital content recovery module and the rendering modules incorporated with the teachings of the present invention. The permanent copy of the programming instructions may be loaded into mass storage 406 in the factory, or in the field, through a distribution medium (not shown) or through communication interface 410 (from a distribution server (not shown).

The constitution of these elements 402-412 are known, and accordingly will not be further described.

Conclusion and Epilog

Thus, it can be seen from the above description, a method and apparatus for advertisement delivery for streaming program has been described. While the present invention has been described in terms of the above-illustrated embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. In a client system, a method of operation comprising
caching a plurality of advertisements of various time lengths; and
causing one or more of said cached advertisements to be synchronously rendered during an advertisement time slot of a streaming program, replacing advertisements, if any, included in the streaming program for the advertisement time slot.

2. The method of claim 1, wherein said caching of a plurality of advertisements of various time lengths comprises providing an advertisement publisher with a profiile of the user of client system.

3. The method of claim 2, wherein said profile of the user of client system comprises selected ones of a plurality of demographic and interest characteristics of the user.

4. The method of claim 2, wherein said profile of the user of client system comprises geographic information of the user.

5. The method of claim 2, wherein the method further comprises receiving said advertisements of various time lengths from the advertisement publisher.

6. The method of claim 2, wherein the method further comprises receiving locations of said advertisements of various time lengths from the advertisement publisher, and retrieving said advertisements of various time lengths from said locations.

7. The method of claim 1, wherein said caching of a plurality of advertisements of various time lengths comprises adaptively retrieving said advertisements in a manner that is consistent with a quality objective for receiving and rendering said streaming program on said client system.

8. The method of claim 7, wherein said adaptive retrieving comprises monitoring one or more performance metrics that are indicative of whether the client system is meeting said performance objective for receiving and rendering said streaming program.

9. The method of claim 7, wherein said adaptive retrieving comprises adjusting at least one of an operational bit rate and an operational pulse rate.

10. The method of claim 1, wherein said caching of a plurality of advertisements of various time lengths comprises caching at least a selected one of 30 second advertisements and 60 second advertisements.

11. The method of claim 1, wherein the method further comprises receiving a notification of the advertisement time slot, including the advertisement time slot's time length.

12. The method of claim 11, wherein said receiving of a notification of the advertisement time slot comprises receiving the notification from a player of the client system receiving and rendering the streaming program.

13. The method of claim 11, wherein said receiving of a notification of the advertisement time slot comprises receiving the notification from an operating system service receiving a streaming of event notifications companion to the streamig program on behalf of a player of the client system.

14. The method of claim 11, wherein said receiving of a notification of the advertisement time slot comprises receiving the notification from a broadcaster of the streaming program.

15. The method of claim 1, wherein said causing of one or more of said cached advertisements to be synchronously rendered during the advertisement time slot comprises selecting one or more of said cached advertisements with their combined total time length at least equals to said advertisement time slot's time length.

16. The method of claim 15, wherein said causing of one or more of said cached advertisements to be synchronously rendered during the advertisement time slot further comprises blocking output of the streaming program for the duration of said advertisement time slot, and rendering the selected advertisement s instead.

17. The method of claim 1, wherein the method further comprises notifying a publisher of an advertisement when rendering commences on the client system for the advertisement.

18. The method of claim 1, wherein the method further comprises notifying a publisher of an advertisement when rendering ceases on the client system for the advertisement.

19. The method of claim 1, wherein the streaming program is a streaming audio program, and the advertisements are audio advertisements.

20. The method of claim 1, wherein the streaming program is a streaming radio program, and the advertisements are audio advertisements.

21. The method of claim 1, wherein the streaming program is a streaming multimedia program, and the advertisements are multi-media advertisements.

22. The method of claim 1, wherein the streaming program is a streaming television program, and the advertisements are television advertisements.

23. The method of claim 1, wherein the method further comprises receiving the streaming program from a broadcaster and rendering the streaming program on said client system.

24. The method of claim 23, wherein the method further comprises receiving a stream of event notifications companion to the streaming program from the broadcaster and relaying notifications of advertisement time slots to an advertisement module responsible for performing said caching of advertisements and said causing of advertisements to be rendered.

25. An apparatus comprising:
storage medium havig stored therein programming instructions designed to enable the apparatus to
cache a plurality of advertisements of various time lengths, and synchronously render one or more of said cached advertisements during an advertisement time slot of a streaming program, to effectively substitute for advertisements, if any, included in said streaming program for rendering during said advertisement time slot; and
at least one processor coupled with the storage medium to execute the programming instructions.

26. The apparatus of claim 25, wherein said programming instructions are designed to enable the apparatus to include as part of the performance of said caching of a plurality of advertisements of various time lengths, provision of an advertisement publisher with a profiile of the user of client system.

27. The apparatus of claim 26, wherein said profile of the user of client system comprises selected ones of a plurality of demographic and interest characteristics of the user.

28. The apparatus of claim 26, wherein said profile of the user of client system comprises geographic information of the user.

29. The apparatus of claim 26, wherein said programming instructions are designed to enable the apparatus to receive said advertisements of various time lengths from the advertisement publisher.

30. The apparatus of claim 26, wherein said programming instructions are designed to enable the apparatus to receive locations of said advertisements of various time lengths from the advertisement publisher, and retrieve said advertisements of various time lengths from said locations.

31. The apparatus of claim 25, wherein said programming instructions are designed to enable the apparatus to include as part of the performance of said caching of a plurality of advertisements of various time lengths, adaptive retrieval of said advertisements in a manner that is consistent with a quality objective for receiving and rendering said streaming program on said client system.

32. The apparatus of claim 31, wherein said programming instructions are designed to enable the apparatus to include as part of the performance of said adaptive retrieving, monitoring of one or more performance metrics that are indicative of whether the client system is meeting said performance objective for receiving and rendering said streaming program.

33. The apparatus of claim 31, wherein said programming instructions are designed to enable the apparatus to include as part of the performance of said adaptive retrieving, adjustment of at least one of an operational bit rate, and an operational pulse rate.

34. The apparatus of claim 25, wherein said programming instructions are designed to enable the apparatus to include as part of the performance of said caching of a plurality of advertisements of various time lengths, caching of at least a selected one of 30 seconds advertisements and 60 seconds advertisements.

35. The apparatus of claim 25, wherein said programming instructions are further designed to enable the apparatus to receive a notification of the advertisement time slot, including the advertisement time slot's time length.

36. The apparatus of claim 35, wherein said programming instructions are designed to enable the apparatus to include as part of the performance of said receiving of a notification of the advertisement time slot, by having an advertisement module receives the notification from a player of the apparatus receiving and rendering the streaming program.

37. The apparatus of claim 35, wherein said programming instructions are designed to enable the apparatus to include as part of the performance of said receiving of a notification of the advertisement time slot, by having an advertisement module receive the notification from an operating system service, of the apparatus receiving a streaming of event notifications companion to the streamig program on behalf of a player of the streaming program of the apparatus.

38. The apparatus of claim 35, wherein said programming instructions are designed to enable the apparatus to include as part of the performance of said receiving of a notification of the advertisement time slot, receipt of the notification from a broadcaster of the streaming program.

39. The apparatus of claim 25, wherein said programming instructions are designed to enable the apparatus to include as part of the performance of said synchronous rendering of one or more of said cached advertisements during the advertisement time slot, selection of one or more of said cached advertisements with their combined total time length at least equals to said advertisement time slot's time length.

40. The apparatus of claim 39, wherein said programming instructions are designed to enable the apparatus to include as part of the performance of said synchronously rendering of one or more of said cached advertisements during the advertisement time slot, blocking of output of the streaming program for the duration of said advertisement time slot, and rendering of the selected advertisements instead.

41. The apparatus of claim 25, wherein said programming instructions are further designed to enable the apparatus to notify a publisher of an advertisement when rendering commences on the client system for the advertisement.

42. The apparatus of claim 25, wherein said programming instructions are designed to enable the apparatus to notify a publisher of an advertisement when rendering ceases on the client system for the advertisement.

43. The apparatus of claim 25, wherein the streaming program is a streaming audio program, and the advertisements are audio advertisements.

44. The apparatus of claim 25, wherein the streaming program is a streaming radio program, and the advertisements are audio advertisements.

45. The apparatus of claim 25, wherein the streaming program is a streaming multi-media program, and the advertisements are multi-media advertisements.

46. The apparatus of claim 25, wherein the streaming program is a streaming television program, and the advertisements are television advertisements.

47. The apparatus of claim 25, wherein said programming instructions are designed to enable the apparatus to receive the streaming program from a broadcaster and render the streaming program on said apparatus.

48. The apparatus of claim 47, wherein said programming instructions are designed to enable the apparatus to receive a stream of event notifications companion to the streaming program from the broadcaster and relaying notifications of advertisement time slots to an advertisement module of the apparatus responsible for performing said caching and synchronous rendering of advertisements.

49. A system comprising:
first server providing at least one of advertisements of various time lengths, and locations of advertisements of various time lengths to a client;
second server providing a streaming program to said client, said streaming program having one or more advertisement time slots; and
said client coupled with the first and second servers to cache said advertisements of various time lengths, and synchronously render one or more of said cached advertisements during a advertisement time slot to effectively substitute for advertisements, if any, included in said streaming program for rendering during said advertisement time slot.

50. The system of claim 49, wherein said client is equipped to adaptively request and retrieve said advertisements of various time lengths in a manner that is consistent with a quality objective for receiving and rendering said streaming program on said client.

51. The system of claim 50, wherein said client is equipped to monitor one or more performance metrics that are indicative of whether the client is meeting said performance objective for receiving and rendering said streaming program.

52. The system of claim 50, wherein said client is equipped to adjust at least one of an operational bit rate, and an operational pulse rate.

53. The system of claim 49, wherein said client is equipped to provide a third server coupled with the client, a user profile of a user of the client.

54. The system of claim 49, wherein said client is equipped to notify a third server when rendering commences on the client for an advertisement.

55. The system of claim 49, wherein said client is equipped to notify a third server when rendering ceases on the client for an advertisement.
